(19) United States
(12) Patent Application Publication
(10) Pub. No.: US 2016/0164230 A1
(43) Pub. Date: Jun. 9, 2016

(54) WALL FEED-THROUGH DEVICE

(71) Applicant: WEIDMÜLLER INTERFACE GMBH & CO. KG, Detmold (DE)

(72) Inventors: Dirk Hanke, Lemgo (DE); Johann Klippenstein, Oelde (DE); Peter Stuckmann, Lage (DE); Peter Walker, Midlothian, VA (US)

(73) Assignee: Weidmueller GmbH & Co. KG, Detmold (DE)

(21) Appl. No.: 14/909,984

(22) PCT Filed: Jun. 23, 2014
(86) PCT No.: PCT/EP2014/063170

§ 371 Date: Feb. 3, 2016

(30) Foreign Application Priority Data
Sep. 9, 2013 (DE) 20 2013 104 068.1

(51) Int. Cl. H01R 13/74

(52) U.S. Cl. CPC H01R 13/74; H01R 13/748

(57) ABSTRACT

A connector assembly for transmitting electrical energy through a wall opening, including a horizontal generally-rectangular first connector housing arranged on one side of the wall with a collar portion of the first housing extending through the wall opening. The collar portion contains a plurality of horizontal parallel coplanar first through bores in which are mounted a plurality of electrically conductive spring contacts, respectively. A second connector housing arranged on the other side of the wall opening contains a recess receiving the collar portion, and a plurality of second bores extending collinearly opposite the first bores, respectively. An electrically conductive comb member includes a plurality of integral pin portions that extend from a common spine portion through the second bores and into the first bores for electrical engagement with the spring contacts, respectively, thereby to connect conductors arranged on opposite sides of the wall.

### REFERENCE TO RELATED APPLICATIONS

This application is a national stage application under 35 C.F.R. §371 of the PCT International Application No. PCT/EP2014/063170 filed Jun. 23, 2014, which claims priority of the German application No. DE 20 2013 104 068.1 filed Sep. 9, 2013.

### BACKGROUND OF THE INVENTION

1. Field of the Invention

A connector assembly serves to distribute electrical energy between conductors arranged on opposite sides of a wall opening, including first and second connector housings arranged on opposite sides of the wall, and a conductive comb member having pin portions that extend through second bores contained in the second housing for electrical engagement with spring contacts arranged in corresponding aligned first bores contained in the first housing.

2. Description of Related Art

A wall on which the wall opening connector assembly is to be fastened can be the wall of a circuit breaker cabinet according to the prior art and also according to the invention. It is often necessary to place several conductors at a plug connector on one side of the wall at a potential and to lead this potential conductively through the wall. For this, two plug connectors are mated on both sides of the wall in the region of an opening in the wall, with corresponding contacts of the two plug connectors being conductively joined together.

According to the prior art, oftentimes screw contacts are used in order to make the conductive connection or to connect the conductor to the plug connectors. Then, as a rule, several conductor ends or bus bars or the like are connected to the two plug connectors. This brings the problem that it may be necessary in a harsh environment to tighten up the screws of these screw contacts from time to time, which is relatively time-consuming. Furthermore, the diversity of parts is relatively high.

Given this background, the problem which the invention proposes to solve is to provide a wall duct unit of simplified design and optimized in regard to its maintenance expense.

### SUMMARY OF THE INVENTION

Accordingly, a primary object of the present invention is to provide a connector assembly for conducting electrical energy through a wall opening between conductors arranged on opposite sides of the wall.

A more specific object is to provide a conductor assembly including first and second connector housings arranged on opposite sides of the wall, and a conductive comb member having pin portions that extend through second bores contained in the second housing for electrical engagement with spring contacts arranged contained in corresponding aligned first bores contained in a collar portion of the first housing that extends into the wall opening.

Another object of the invention is to provide a connector arrangement including a horizontal generally-rectangular first connector housing arranged on one side of the wall with a collar portion of the first housing extending through the wall opening. The collar portion contains a plurality of horizontal parallel coplanar first through bores in which are mounted a plurality of electrically conductive spring contacts, respectively. A second connector housing arranged on the other side of the wall opening contains a recess receiving the collar portion, and a plurality of second bores extending collinearly opposite the first bores, respectively. An electrically conductive comb member includes a plurality of integral pin portions that extend from a common spine portion through the second bores and into the first bores for electrical engagement with the spring contacts, respectively, thereby to connect conductors arranged on opposite sides of the wall. Fastener means serve to firmly connect together the housings arranged on opposite sides of the wall.

According to the invention, the conductor ends are soldered to or placed by plug connectors (for example, in the manner of bayonet-type connectors) on a comb connector. This comb connector has contact pins that are inserted through the housing of the one plug connector into engagement with spring contacts of the other plug connector.

Thus, on one side of the wall there only needs to be provided a single conductive part on the plug connector at one of the two plug connectors. For on the one hand the conductor ends can be fixed (by soldering or insertion) free of vibration in the region of the spine on the comb connector and it is also possible to configure all contact pins or the contact pins of the connector on these comb connectors, because the contact pins are so long that they can be used directly for contacting the spring contacts of the second plug connector. The solution requires only a few parts, is easy to install, and requires little maintenance.

### BRIEF DESCRIPTION OF THE DRAWINGS

Other objects and advantages of the invention will become apparent from a study of the following specification, when viewed in the light of the accompanying drawing, in which:

FIGS. 1a and 1b are perspective views, respectively, of two embodiments of the through-wall connector assemblies of the present invention;

FIG. 1c is an exploded view of the assembly including the conductive comb members of FIG. 1a and 1b; and

FIG. 1d is a sectional view of the apparatus of FIG. 1b.

### DETAILED DESCRIPTION OF THE INVENTION

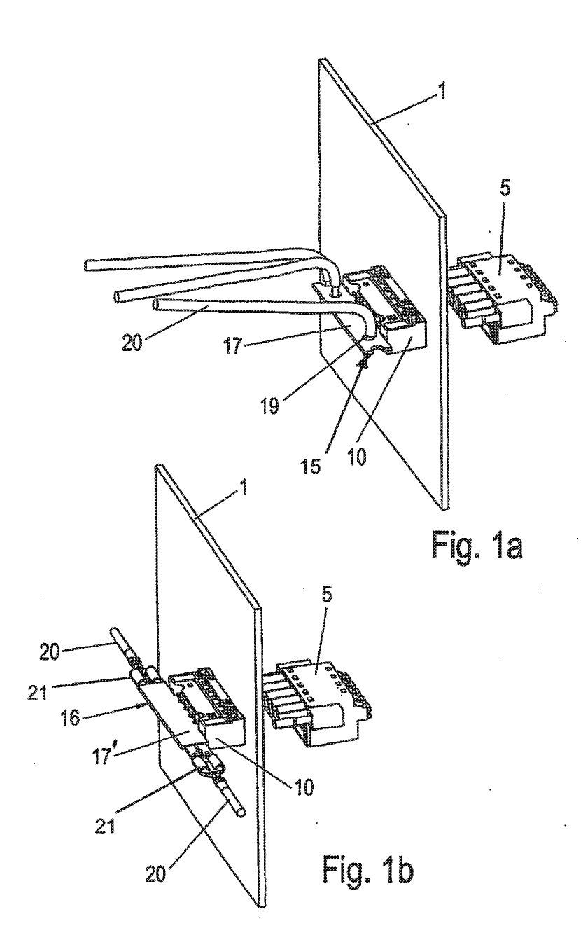

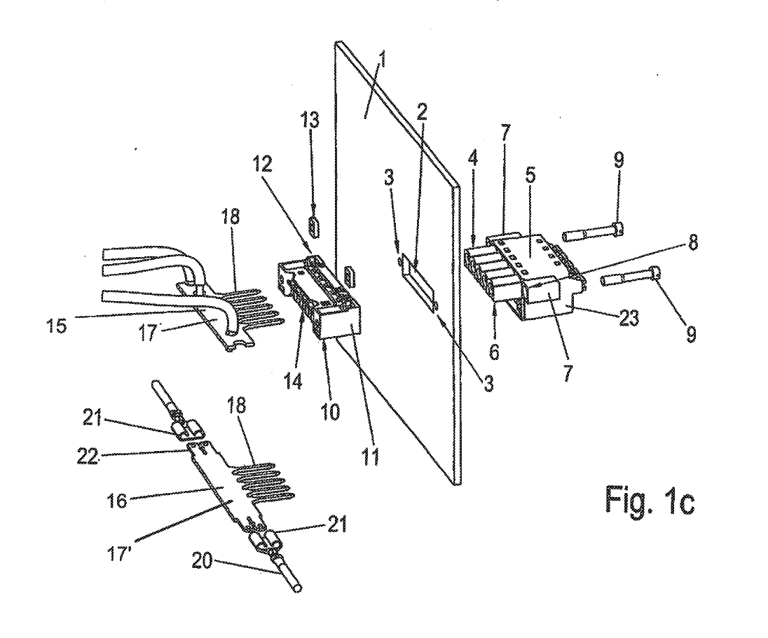

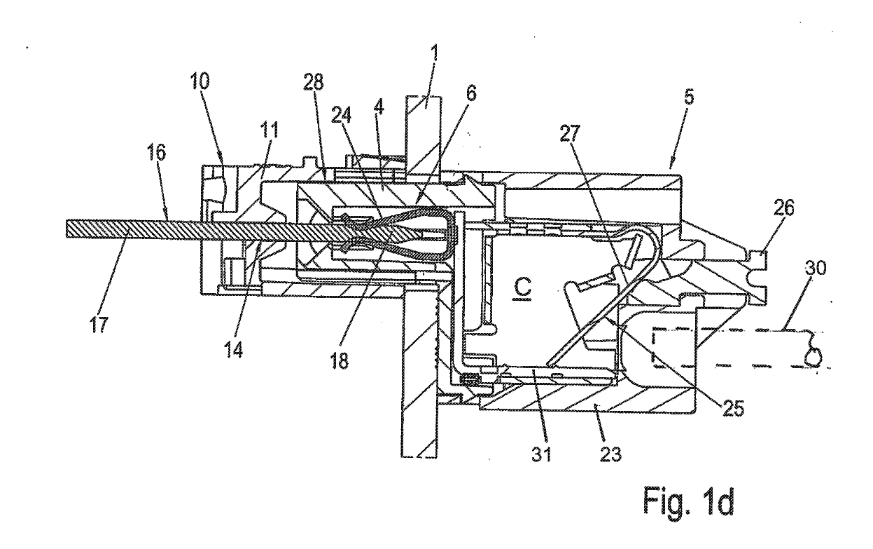

Referring first to FIGS. 1a and 1g, the vertical wall 1 contains a peripherally closed opening 2 in the manner of a window. The opening 2 is rectangular here in preferred configuration, but it can also have a different geometry. Through holes 3 (FIG. 1c) are formed in the wall on either side of narrow sides of the opening.

The wall opening 2 is configured to receive the collar portion 4 of the housing 23 of a first connector 5 arranged on one side of the wall. This collar portion 4 contains a plurality of parallel coplanar first through bores 6 that communicate at one end with a chamber C contained in the first housing 23. Mounted in these first bores are a plurality of tulip-shaped spring contacts 6, respectively, which spring contacts are electrically connected with stationary L-shaped contacts having leg portions 31 mounted in the bottom of the first housing chamber C adjacent access openings 29. A resilient V-shaped leaf spring 25 has a support leg secured to the top of the chamber C, and a clamping leg that extends adjacent a housing access opening 29. This clamping leg serves to bias toward engagement with the stationary contact portion 31 the bare end of a conductor 30 introduced into the chamber C via the access opening 29. A longitudinally displaceable push member 26 is manually operable to displace the clamping leg of leaf spring 25 from its illustrated clamping position toward a retracted position relative to the stationary contact 31.

The housing 23 of the first plug connector 5 has lateral shoulders 7, which are provided with through holes 8, through which bolts 9 can be inserted. The through holes 8 are arranged on the plug connector 5 such that they are aligned with through holes 3 formed in the wall on opposite sides of the opening wall opening 2. in the state in which the first plug connector 5 is placed at the opening 2 of the wall 1 so that its connector face collar 4 protrudes through the opening 2. The screws 9 are long enough to project on the other side of the wall 1 when inserted through the through holes 8.

On the other side of the wall 1 there is provided a second plug connector 10 having a second housing 11. This second housing 11 has non-circular recesses 12 for receiving nuts 13. Preferably, the recesses 12 and the nuts 13 are each rectangular in their outer circumference, so that the nuts 13 are held without twisting in the recesses 12. The recesses 12 are arranged with through holes 14 passing through them so that it is possible to install bolts 9 into the nuts 13 of the housing 11. In this way, the arrangement of the first plug connector 5 and the second plug connector 10 is fixed at the opening 2 of the wall 1.

The second housing 11 contains a recess 28 (FIG. 1d), which receives the end extremity of the collar portion 4 of the first plug connector 5. On the side facing away from this receptacle and the wall 1 the housing 11 is provided with a row of second through bores 14, whose positions correspond collinearly to the positions of the first bores 6 in the collar portion of the first plug connector 5.

In simple manner, the contacting of the spring contacts 24 in the first bores 6 of the first plug connector 5 is accomplished by an electrically conductive comb connector 15 (FIG. 1a) or 16 (FIG. 1b). Each comb connector 15 or 16 has a spine portion 17, 17′ from which a plurality of parallel spaced coplanar contact pins 18 project. The contact pins 18 are dimensioned so that they can be inserted through the through openings 14 into the housing 10 to make contact with the spring contacts supported in the first bores 6 of the collar portion 4 of the first plug connector 5. Owing to the spine portions 17, 17′, the contact pins 18 are conductively joined together, so that the same potential exists overall on all contact pins 18 at the connection combs 15, 16.

According to the embodiment of FIG. 1a, the comb spine portion 17 is provided with holes 19. These holes 19 are configured such that the bare conductor ends of conductors 20 with the insulation stripped off can be inserted into them. The conductor ends can then be soldered to the lower surface of the spine portion 17. In this way, several conductors, such as three, four or more conductors can be placed on the spine portion 17 with the same potential. It is advantageous that an arrangement is created thanks to the spring contact configuration, especially in a configuration as tulip contact (24) or direct insert (push-in) contacts with clamping cage and V-shaped clamping spring, with which a long-lasting and secure contact is realized between the plug connectors 5, 10, without it being necessary to tighten up the individual contacts (which may be the case with screw contacts, for example).

In the second embodiment of FIG. 1b, the conductors 20 are connected to the spine portion 17′ not by means of soldering but by means of bayonet connections 21 to correspondingly fashioned ends 22 of the spine. This solution as well is easy to install and requires little maintenance.

In both embodiments, electrical energy is transmitted from conductors 20 on one side of wall 1 to conductors 30 on the other side of the wall via spine portions 17, 17′, pins 18, spring contacts 24, and stationary contacts 31.

While in accordance with the provisions of the Patent Statutes the preferred forms and embodiments of the invention have been illustrated and described, it will be apparent to those skilled in the art that changes may be made without deviating from the invention described above.

1. (canceled)

2. (canceled)

3. (canceled)

4. (canceled)

5. (canceled)

6. (canceled)

7. (canceled)

8. (canceled)

9. (canceled)

10. A connector assembly for distributing electrical energy though an opening (2) contained in a vertical wall (1), comprising:
(a) a first plug connector (5) including a generally rectangular first housing (23) arranged on one side of said wall opening, said first housing containing a chamber (C) and having a horizontal collar portion (4) extending through said wall opening, said first housing collar portion containing a plurality of horizontal parallel coplanar first through bores (6) extending longitudinally through said first housing collar portion in communication at one end with one end of said first chamber;
(b) a plurality of electrically conductive spring contacts (24) arranged in said first bores, respectively, said spring contacts being adapted for connection with a plurality of first conductors (30), respectively;
(c) a second plug connector (10) having a rectangular second housing (11) arranged on the other side of said wall opening, said second housing containing a plurality of second through bores (14) opposite and extending collinearly with said first bores, respectively; and
(d) an electrically conductive comb member (15; 16) having a horizontal spine portion (17; 17′) adapted for connection with at least one second conductor (20), and a plurality of parallel spaced integral pin portions (18) extending from said comb spine portion though said second bores and into said first bores toward electrical engagement with said spring contacts, respectively.

11. A connector assembly as defined in claim 10, and further including at least one second conductor (20) having a bare end electrically connected with said comb spine portion.

12. A connector assembly as defined in claim 11, wherein said second conductor bare end portion extends through an opening (19) contained in said comb spine portion (17) and terminates in an extremity that is soldered to said comb spine portion.

13. A connector assembly as defined in claim 11, and further including a bayonet fitting (21, 22) electrically connecting said second conductor bare end with said comb spine portion (17′).

14. A connector assembly as defined in claim 10, wherein said second housing includes a side wall containing a recess (28) adjacent said wall opening, said first housing collar portion having an end extremity extending into said recess.

15. A connector assembly as defined in claim 10, wherein said spring contact (24) is generally tulip-shaped.

16. A connector assembly as defined in claim 15, wherein said first housing contains for each first bore an access opening (29) communicating with the opposite end of said first chamber; wherein each spring contact includes a stationary contact portion (31) extending into said first housing chamber adjacent said access opening;
and further including a resilient clamping spring (25) arranged in said first housing chamber adjacent said access opening for biasing into electrical engagement with said stationary contact portion the bare end of a first conductor (30) inserted into said first housing chamber via said access opening.

17. A connector assembly as defined in claim 16, wherein said clamping spring has a generally V-shaped configuration and includes a support leg secured to a wall of said first housing chamber, and a clamping leg extending adjacent said access opening.

18. A connector assembly as defined in claim 17, wherein said clamping leg is displaceable between clamping and released positions relative to said stationary contact portion; and further including a displacing device (26) for displacing said clamping leg from said clamping position toward said released position.

19. A connector assembly as defined in claim 14, and further including fastening means (9, 13) for fastening together said first and second housings.

20. A connector assembly as defined in claim 19, wherein said fastening means includes a threaded bolt (9) and an associated nut (13).
